(19) United States
(12) Patent Application Publication
(10) Pub. No.: US 2026/0121174 A1
(43) Pub. Date: Apr. 30, 2026

(54) High Power and High Energy Supercapbattery Device and Method of Making Same

(71) Applicant: Manoj Kumar RAM, Palm Harbor, FL (US)

(72) Inventor: Manoj Kumar RAM, Palm Harbor, FL (US)

(21) Appl. No.: 18/978,094

(22) Filed: Dec. 12, 2024

Related U.S. Application Data
(60) Provisional application No. 63/711,990, filed on Oct. 25, 2024.

(51) Int. Cl. H01M 12/02; H01G 11/06; H01G 11/48; H01G 11/50; H01G 11/56; H01G 11/86; H01M 4/60; H01M 10/0525; H01M 10/0565; H01M 10/058

(52) U.S. Cl. CPC H01M 12/02; H01G 11/06; H01G 11/48; H01G 11/50; H01G 11/56; H01G 11/86; H01M 4/604; H01M 4/606; H01M 10/0525; H01M 10/0565; H01M 10/058; H01M 2300/0082

(57) ABSTRACT

The invention is about energy storage device “supercapbattery” which acts both like supercapacitor and battery. The supercapbattery consists of first electrode (cathode), second electrode (anode) and between electrolyte socked with and without separator. The supercapbattery consists of cathode electrode is based on composite of conducting polymer composite with transition metal sulfide. The second electrode (anode) which is the pyrolyzed composite of phytolith coated with conducting polymer. The electrolyte is the gel polyvinyl alcohol or separator socked ionic liquid or the inorganic salt in organic solvent. The supercapbattery is packed using adhesive polymer after the connection of electrodes are made. The supercapbattery offers lightweight ‘high power and energy’ storage that can save space and weight in wearable equipment used for the military and medical applications. The high power and energy densities in the SCB, the flexible structure allows for a more efficient and ergonomic design of the equipment with greater cost-effectiveness.

### CROSS-REFERENCE TO RELATED APPLICATIONS

This application claims priority to U.S. Provisional Patent Application No. 63/711,990, filed on 25 Oct. 2024, the entire contents of which are fully incorporated herein by reference.

### STATEMENT REGARDING FEDERALLY SPONSORED RESEARCH

This invention was made with government support under the contract number: FA864921P0029 awarded by US AIR Force (USAF) Research Lab AFRL SBRK. The government has certain rights in the invention.

### REFERENCE TO A SEQUENCE LISTING

Not Applicable

### FIELD OF THE INVENTION

The supercapbattery (SCB) combines the properties of both supercapacitor and lithium-ion battery. It is a comparatively a modern system to give energy like a battery and power density like a supercapacitor and can maintain a high cyclability. It has asymmetric configuration consisting of supercapacitor electrode as well as lithium-ion battery electrode. The design of SCB exhibiting energy density like that of a battery and power density like a supercapacitor can be achieved by using novel, large-surface-area pseudocapacitive electrode materials that exhibits redox properties and facilitate multi-electron transfer. PolyMaterials brings an innovative solution for the development and construction of a highly efficient energy storage device” SCB.” The supercapbattery consists of cathode, electrolyte, separator, and carbon-silicon or lithium doped carbon-silicon based anode electrode. The charges are deposited asymmetrically and concurrently during the charge and discharge cycles which is like surface ion adsorption and desorption on capacitor like electrode whereas the Li⁺ ion is intercalated & deintercalated like battery type of electrode. The battery and capacitor type of supercapbattery works in various potential windows enhancing the high energy density by expanding the operating voltages. The energy and power densities of supercapbattery depend on the configuration of electrode materials. Lithium-ion battery (LIB) is a key electrical energy device of electrification to several electronics devices and all modern transportation besides the storing energy from the grid to power electric vehicles. The energy density of LIB is increased by using silicon which has ten times greater lithium iron storage capacity than graphite (3579 mAh/g vs. 372 mAh/g) and other carbon materials that are typically used as the anode in batteries. Lithiated graphite binds one lithium ion per six carbon atoms, whereas elemental silicon binds almost four lithium ions per Si atom (22.5×). This makes lithium-silicon batteries the holy grail of charge storage technology.

We are using the natural materials which is Phytoliths; it contains silicic acid in cellulose. The cellulose relates to silicic acid through hydrogen bonds to OH groups. The high surface area of many kinds of phytoliths which include spiked, knobbed, concave, porous, and tubular structures maximizes the ion exchange surface. Exposure to high heat (for example 600° C.) burns off the oxygen atoms from the surface of the phytoliths, leaving elemental carbon-silicon oxide. The heat-treated and/or conducting polymer coated phytoliths comprise an ideal charge storage material that retains its structure while adsorbing lithium ions.

### BACKGROUND

A supercapacitor is an electrochemical device which stores and releases electricity like a battery, but the biggest advantage is it can be charged in few seconds instead of hours like battery [1]. Generally, supercapacitors are also known to have long operational lifetimes compared to chemical batterie's with minimal change in performance [2]. Supercapacitors have numerous applications in consumer electronics, medical devices, appliances, transportation technologies like electric hybrid vehicles, aerospace and defense sectors [3-5]. The supercapacitor has already found place in data storage application replacing the batteries, which requires high to medium current for short duration of time. The supercapacitor delivers higher power, lower or smaller form factor, weight, wider temperature range operating condition, low ESR, more safety, and longer life and environmental stability [6, 7].

One of the limitations of supercapacitor is the maximum voltage of 2.5 to 2.75 V per cell which is lower than 3.5-4.0 V per cell of lithium battery. Besides, the lifetimes are also dependent to the high charge voltages or the charging at elevated temperatures. The battery has better energy density but lower power density than supercapacitor. The battery has also high equivalent circuit resistance (ESR) at cold temperatures. The supercapacitor has mismatched capacitances, ESR and capacitances degrading at different rate causing overvoltage of cells which in fact need attention of power balancing. The supercapacitor still needs higher energy densities for applications in electric drive vehicle and electric hybrid vehicle.

The present invention is about development of supercapbattery showing high power density like supercapacitor and energy density like battery. FIG. 1 shows the Ragone plot of the electrochemical energy system and the supercapbattery holds to show the high energy and high-power densities. FIG. 2 Shows the schematic of supercapbattery. The supercapbattery consists of cathode, anode, electrolyte with or without separator.

Comparison of lithium-ion battery, supercapacitor and supercapbattery and their mechanism of charging is shown in FIG. 3. The supercapbattery (SCB) combines the properties of both supercapacitor and lithium-ion battery. It is a comparatively a modern system to give energy like a battery and power density like a supercapacitor and can maintain a high cyclability. It has asymmetric configuration consisting of supercapacitor electrode as well as lithium-ion battery electrode. The design of SCB exhibiting energy density like that of a battery and power density like a supercapacitor will be achieved by using novel, large-surface-area pseudocapacitive electrode materials that exhibits redox properties and facilitate multi-electron transfer. PolyMaterials brings an innovative solution for the development and construction of a highly efficient energy storage device” SCB.” The charges are deposited asymmetrically and concurrently during the charge and discharge cycles which is like surface ion adsorption and desorption on capacitor like electrode whereas the Li+ ion is intercalated & deintercalated like battery type of electrode. The battery and capacitor type of supercapbattery works in various potential windows enhancing the high energy density by expanding the operating voltages.

The asymmetric supercapbattery containing the highly surface area-based electrodes where first electrode is containing the nanocomposite electrode, and the second electrode is containing pyrolyzed phytolith with and without conducting polymer coating. The supercapbattery can also be constructed through a very high functional anode or cathode from battery and matching with the other electrode of supercapacitor. The innovative supercapbattery addresses the issues of performance at high rates of discharge and high energy density and survivability capable of performing the desired properties of energy storage device like battery.

The energy and power densities of supercapbattery depend on the configuration of electrode materials. In general, the capacitor types the electrode is chosen for large surface area electrode which can be activated carbon, cellulose pyrolyzed nitrogen and phosphorus doped carbon, graphene etc. The mechanism for electric double layer capacitor, it is simple adsorption and desorption of the ions within the electrode, however, the asymmetric capacitor with pseudo has anticipation of ions increasing the capacitance as well as energy.

### Phytolith

There are large varieties of phytolith plants such as Grasses (Poaceae), Sedges (Cyperaceae): Eudicots, Fern phytoliths, Palms (Arecaceae) and Cacti (Cactaceae), Bamboo contains silicon accumulation in diclot clades which can be used for fabrication of carbon-silicon based anode electrode. The high surface area of kinds of phytoliths which include spiked, knobbed, concave, porous, and tubular structures maximize the ion exchange surface (FIG. 4). Phytolith plant consists of silicic acid in cellulose along with water. It is also connected with nitrogen, water and carbon including other nutrient materials of plant. There is a large variation of carbon to silicon in the phytolith plants [8]. Varying from 1 to 20%. FIG. 5 (a&b) shows the structure and cartoon of phytoliths with silicic acid in cellulose. Phytoliths are composed of amorphous (non-crystalline, opal A) silicon dioxide (SiO₂) and water (4-9% wt.), with a minor admixture of other chemical elements. The percentage of carbon to silicon in a phytolith is typically very low, ranging from around 0.1% to 2.5% carbon trapped within the silica structure, meaning for everyone hundred parts silicon, there is only 1-2.5 parts carbon trapped inside the phytolith. It is therefore not surprising that the conical-shaped phytoliths have high C concentrations (range 8.3% to 34.7%; mean: 18.7%), while Si concentrations ranged from 15.6% to 35.3% (mean: 26.9%. A polymer made of β (1→4) linked glucose units, forming long, linear chains. These chains can aggregate to form microfibrils, which are essential components of plant cell walls. Silica particles can deposit on the surface of cellulose microfibrils within plant tissues. This deposition occurs during the growth of the plant, where dissolved silica from the soil is taken up and later precipitates as phytoliths. While silica does not chemically bond with cellulose, hydrogen bonding can occur between hydroxyl groups on the cellulose and water molecules, with silica potentially influencing these interactions (FIG. 5 a &b). In phytoliths, while silicon does not form direct chemical bonds with cellulose, silicic acid can enhance silicon uptake and deposition, contributing to the overall structural integrity of plant tissues [9, 10]. FIG. 5 shows the schematic presentation of cellulose-salicylic acid (a): structure and (b) cartoon showing the salicyclic acid embedded in cellulose (presented as line). The natural nanostructure of phytoliths can provide a high surface area, which is beneficial for lithium-ion diffusion and overall battery performance. Phytoliths primarily consist of silica (SiO₂), which can be converted to silicon (Si). Silicon has a theoretical capacity of about 4,200 mAh/g, significantly higher than traditional graphite anodes (around 372 mAh/g). The natural structure of phytoliths can provide a high surface area and porosity, which can enhance lithium-ion diffusion and improve overall battery performance. The electrochemical reduction of silicon oxide (SiO₂) in a carbon-silicon environment presents a promising pathway for producing silicon with potential applications in energy storage and beyond. While there are challenges to overcome, ongoing research and development could enhance the viability and efficiency of this process, contributing to more sustainable materials production. The electrochemical reduction of silicon in a salt medium (magnesium chloride) offers a promising route for producing high-purity silicon and silicon-based materials. However, phytoliths can be separated from the natural plant matrix and mixed with cellulose or artificial electro-chemical polymers in various ratios. By manipulating the ratio of phytoliths to polymer, the balance between charge density and volume stability can be optimized for various applications.

The energy efficiency of SCBs can be significantly enhanced due to the large working voltage of the battery-type electrodes as carbon-silicon.

### SUMMARY

The invention includes an innovative solution for the development and construction of a highly efficient energy storage device supercapbattery (SCB). The supercapbattery consists of first electrode, second electrode on graphite and between separator shocked in electrolyte. The SCB is packed using adhesive polymer after the connection of electrodes are made. The supercapbattery consists of first electrode from composite of conducting polymer composite with transition metal sulfide. The second electrode which is the pyrolyzed composite phytolith (rice (Oryza sativa, Sugarcane (Saccharum officinarum). Bamboo (Bambusoideae), Sorghum (Sorghum bicolor, Horsetail (Equisetum), Eucalyptus containing the silicic acid with cellulose with conducting polymer. The first and second electrode were in sandwiched structure having in middle the polyvinyl alcohol gel electrolyte or separator socked ionic liquid or lithium ion based organic electrolyte. The anode electrode is based on the pyrolyzed composite of phytolith-conducting polymer which is further reduced electrochemically in the molten salt bath, The presence of nitrogen inserted which stabilizes the Si—C structure in transfer of lithium ion. The lithium as ion in the supercapbattery shows the potential window from 1 to 3.8V. The developed supercapbattery will find application in hybrid vehicle, military, satellite communication and aerospace applications due to high energy and high power with thousand times of charging and discharging cycles including the high-rate discharge over time.

### BRIEF DESCRIPTION OF THE DRAWINGS

FIG. 1: Schematic showing plot of supercapbattery with other electrochemical storage devices

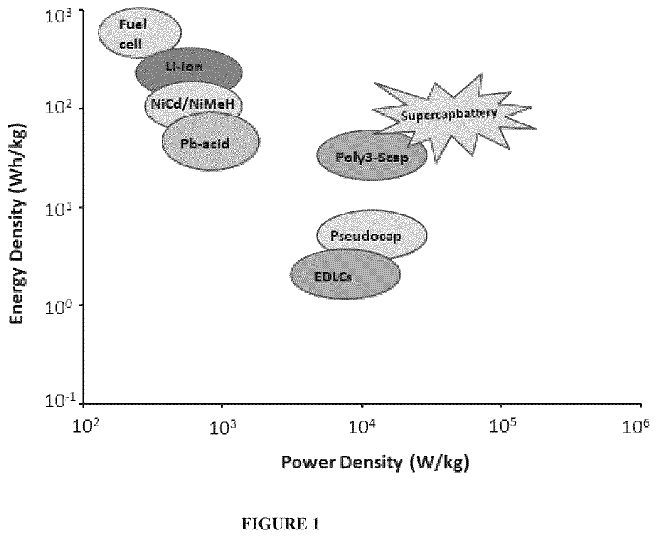

FIG. 2: Shows the schematic of supercapbattery

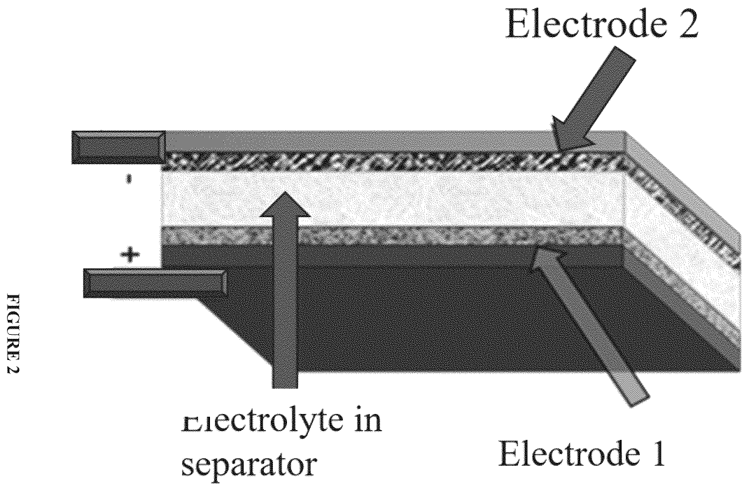

FIG. 3: Comparison of lithium-ion battery, supercapacitor and supercapbattery and their mechanism of charging

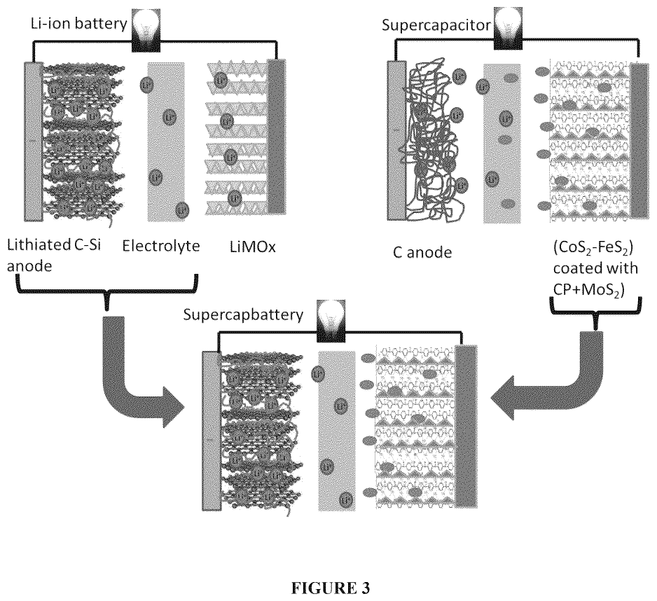

FIG. 4: Photomicrographs of phytoliths embedded in plant tissues or isolated as free phytoliths (ref: 1,2)

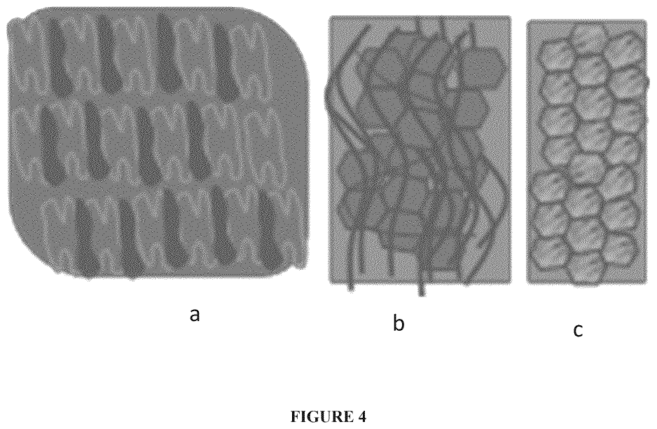

FIG. 5: (a) Schematic presentation of Cellulose-silicic acid: structure and 5(b) cartoon showing the salicyclic acid embedded in cellulose (presented as line)

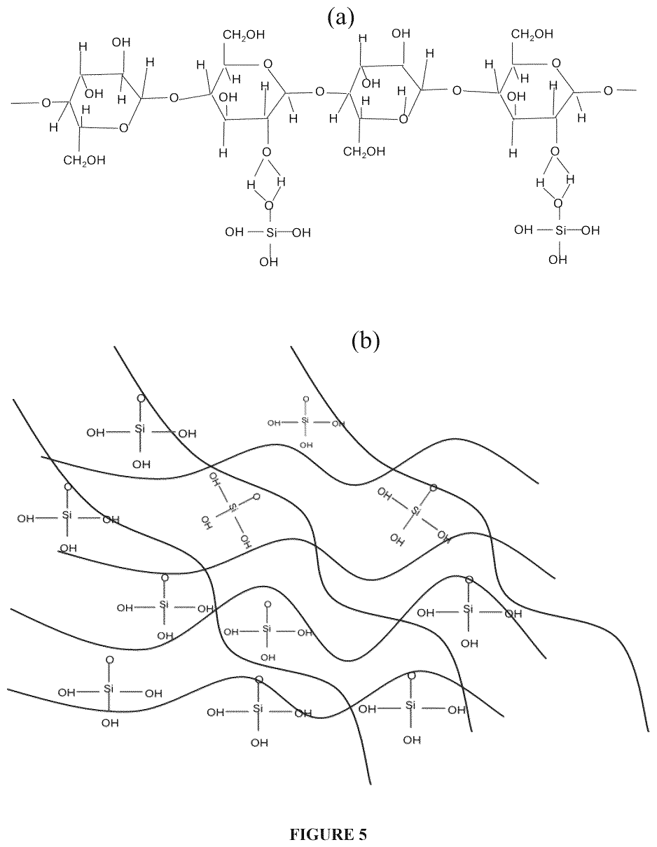

FIG. 6: Schematic showing the electrochemical reduction for preparation of anode C—Si electrode

FIG. 7: Schematic of a charged supercapbattery with silicon in carbon

FIG. 8. The PolyMaterials supercapbattery showing materials with various application.

### DETAILED DESCRIPTION

Prior to any embodiments of the invention being disclosed, it is made to know here that it is apparent to an artisan of this field of energy storage that the invention described here-in is not limited in the fabrication and testing of supercapbattery. The invention is capable of other embodiments and of being practiced or of being conducts in numerous ways.

### Definitions

Unless otherwise defined, all technical and scientific terms used herein have the same meaning as commonly understood by one of ordinary skill in the art. In case of conflict, the present document, including definition, will control. Preferred methods, methodology and materials are described below, although methods and materials similar or equivalent to those described herein can be used in practice or testing of supercapbattery the present invention. All publications, patent applications, patents, and other references mentioned herein are incorporated by reference in their entirety. The materials, methods, and supercapbattery invention disclosed herein are illustrative only and not intended to be limiting.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” and “consisting of,” the embodiments or elements presented herein, whether explicitly set forth or not.

The invention described here-in provides a unique supercapbattery energy storage product which is fabricated from electrode 1 (cathode) and electrode 2 (anode). The present invention is described in enabling detail in the following, which may represent more than one embodiment of the present invention.

The supercapbattery consist between first electrode (cathode) and second electrode (anode) in between either polyvinyl alcohol water based, or lithium ion based organic electrolyte with and without spacer. The supercapbattery consists of first electrode from composite of conducting polymer composite with transition metal sulfide which is selected from Polyaniline(PANI)-iron sulfide (FeS₂), PANI-titanium sulfide (TiS₂), PANI-molybdenum sulfide (MoS₂), PANI (vanadium sulfide) (VS₂), PANI-chromium sulfide (CrS), PANI-copper sulfide (CuS), PANI-nickel sulfide (NiS₂), pol (poly(ortho-anisidine) (POAS)-MoS₂, poly(o-toluidine) (POT)-FeS₂, poly(ethoxy-aniline) (POEA))-MoS₂, substituted polyanilines-MoS₂, polypyrrole-MoS₂, substituted polypyrroles-MoS₂, polythiophenes-S, polyindole-MoS₂, polycarbazole-MoS₂, substituted polycarbazole-MoS₂, polypyrrole-MoS₂, polyhexylthiophene-MoS₂ polyethylenedioxythiophene-MoS₂, methylthiophene-MoS₂, polydodcylthiophene-MoS₂, polycarbazole-MoS₂, poly(n-vinylcarbazole)-MoS₂, substituted polyethylenedioxythiophene-MoS₂, polydiooxythiophene-MoS₂, n-Poly(N-methyl aniline)-MoS₂, poly(o-ethoxyaniline), poly(o-toluidine)-MoS₂, poly(phenylene vinylene)-MoS₂, PANI-MoSe₂, PANI-MoTe₂, PANI-WS₂, PANI-WSe₂, PANI-WTe₂ and their combinations. The second electrode which is the pyrolyzed composite phytolith (rice (Oryza sativa, Sugarcane (Saccharum officinarum). Bamboo (Bambusoideae), Sorghum (Sorghum bicolor, Horsetail (Equisetum), Eucalyptus containing the salicylic acid with cellulose coated by conducting polymer (poly(ortho-anisidine) (POAS), poly(o-toluidine) (POT), poly(ethoxy-aniline) (POEA), substituted polyanilines-polypyrroles, substituted polypyrrole-, polythiophenes, polyindole, polycarbazole, substituted polycarbazole, polypyrrole, polyhexylthiophene-polyethylenedioxythiophene, methylthiophene, polydodcylthiophene-, polycarbazole, poly(n-vinylcarbazole), substituted polyethylenedioxythiophene, polydiooxythiophene, n-poly(N-methyl aniline), poly(o-ethoxyaniline), poly(o-toluidine), poly(phenylene vinylene), polyaniline and their combination for obtaining the nitrogen doped carbon-silicon electrode.

The first and second electrode are sandwiched structure having in middle the polyvinyl alcohol (PVA)-HCl, PVA-G-HCl PVA-H₃PO₄, or PVA-H₂SO₄ gel electrolyte or separator socked ionic liquid ((1-ethyl-3-methylimidazolium bis(trifluoromethylsulfonyl)imide (EMI-TFSI), 1-Ethyl-3-methylimidazolium Bis(trifluoromethylsulfonyl)imide [EMIm-Tf2N], and 1-Methyl-1-propyl piperidinium Bis(trifluoromethane)sulfonimide [MPPip-TFSI], etc.) or combination thereof or lithium salt in propylene-ethylene carbonate solvent.

The anode electrode is based on the pyrolyzed composite of phytolith-conducting polymer which is further reduced electrochemically in the molten salt bath, The presence of nitrogen inserted which stabilizes the silicon-carbon (Si—C) structure in transfer of lithium ion. The lithium as ion in the supercapbattery shows the potential window from 2.5 to 3.8V whereas the PVA based electrolyte shows the potential window of up to 1.2 V. The lithiation, the working voltage and the mass ratio of cathode to anode are the keys for cyclic stability, power efficiency, power, and energy capacities. The prelithiation can be made in both anode and cathode electrode or single electrode anode or cathode electrode. Besides, the design of the electrode which are having large surface area as well as pseudocapacitative materials are preferred.

Anode Preparation from Phytolith

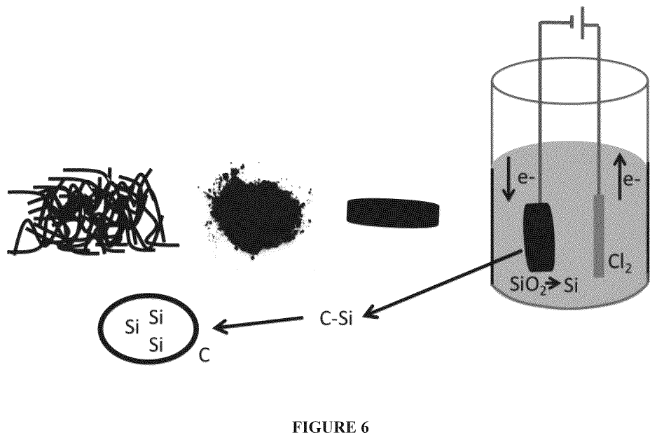

In living plants, phytoliths are embedded in structural material primarily composed of cellulose and other natural polymers. Naturally, cellulose is a thermal and electrical insulator. To be made conductive, it must be treated by nitrogen (N) doping and/or by pyrolysis or other methods. Pyrolysis under nitrogen or argon) burns off non-conducting elements while retaining the carbon skeleton of the material. The highly branching nature of cellulose and other polysaccharides offers a high surface area for charge storage and the obtained carbon is conducting. The silicon in phytoliths is as silicon dioxide which is an insulator that can be made conductive by N and P doping and pyrolysis. Exposure to high heat (for example 600° C.) burns off the oxygen atoms from the surface of the phytoliths, leaving elemental silicon that is free to bind lithium ions. Since these binding sites are found at the surface rather than the interior of the phytoliths, the expansion of the charged crystals is attenuated. In this manner, heat-treated and/or doped phytoliths comprise an ideal charge storage material that retains its structure while adsorbing lithium ions. We understand that the silicon is still bonded with oxygen so the electrolysis method will be attempted to remove any oxygen from the structure using the method described in reference. The stability, conductivity of the Si—C from phytoliths (bio-SiO₂) is the key to the performance of the LIB electrodes and will be thoroughly investigated as carbon materials. Further, the Si—C or N doped Si—C obtained by pyrolysis as well as electrolysis technique will be used as an anode by lithium process. The lithium can be incorporated into the electrode by both electrochemical and sputtering techniques for better intercalation/deintercalation of lithium ions. FIG. 6 shows the electrochemical reduction of SiO₂ for the preparation of C—Si electrode. The electrochemical reduction is made in molten salt at around 600° C. The electrolysis in molten salt bath converts silica to silicon by electrochemical reduction process. The reaction at the cathode is shown in equation 1.

$${MgCl}_{2} + C - Si {O}_{2} = {C}_{x} - Si + 2 M g O + Cl 2 ( g ) \qquad ( 1 )$$

### Cathode Electrode Material for SCB

The iron pyrite, FeS₂; “fool's gold”, cobalt pyrite, CoS₂; cattierite, nickel pyrite, NiS₂; vaesite etc. have recently gained attention as high-capacity conversion cathode materials for rechargeable LIBs. FeS₂ the based electrode has a high theoretical capacity of 894 mAh/g and a high theoretical energy density of 1313 Wh/kg. The CoS₂ has been used as an electrode in LIB showing a high discharge capacity (1210 Whr/Kg) with good cycle stability. The CoS₂/multi-walled carbon nanotubes (MCNFs) show a capacity of 620 Whr/Kg at 1 A/g. A first the discharge capacity of 1050 Whr/Kg has been obtained which is higher than the theoretical capacity of FeS₂ (894 mAh/g). The anchored graphene nanosheets with CoS₂-quantum-dots (CoS₂NP@graphene (G)-CoS₂ quantum dot (QD) has a specific capacity of 1048 Whr/Kg with 831 Whr/Kg even at 1 A/g even after three hundred cycles. Table 1 shows the energy density obtained using various metal pyrite materials. The FeS₂ has been synthesized in different forms to overcome the low cyclability drawback. The FeS₂ and FeS₂-carbon nanotubes in powder have been prepared by different techniques for cathode materials for LIB applications. The CoS₂ with lithium shows the 146 kJ.mol so it is better to use with FeS₂. FeS₂ should be a structure that could easily intercalate the lithium-ion and be modified with CoS₂. CoS₂ increases the stability of FeS₂ by reducing the release of sulfur in the charging and discharging process. Therefore, the use of porous micro-grid current collectors is utilized. The metal sulfide is coated with conducting polymer as following (poly(ortho-anisidine) (POAS), poly(o-toluidine) (POT), poly(ethoxy-aniline) (POEA), substituted polyanilines-polypyrroles, substituted polypyrrole-, polythiophenes, polyindole, polycarbazole, substituted polycarbazole, polypyrrole, polyhexylthiophene-polyethylenedioxythiophene, methylthiophene, polydodcylthiophene-, polycarbazole, poly(n-vinylcarbazole), substituted polyethylenedioxythiophene, polydiooxythiophene, n-poly(N-methyl aniline), poly(o-ethoxyaniline), poly(o-toluidine), poly(phenylene vinylene), polyaniline and their combination.

TABLE 1
Specific capacities and energy densities
for some of the metal sulfides [11-18]

| | Specific capacity | Energy density | Energy density |
|---|---|---|---|
| Material | (mAh/g) | (Wh/kg) | (Wh/L) |
| S | 1675 | 2500 | 2800 |
| FeS₂ | 894 | 1341 | 6705 |
| TiS₂ | 239 | 959 | 3200 |
| MoS₂ | 134 | 536 | 2712 |
| VS₂ | 466 | 550 | 2300 |
| CrS | 650 | 650 | 3120 |
| CuS | 561 | 1122 | 5161 |
| NiS₂ | 590 | 826 | 4543 |
| CoS₂ | 870 | 1305 | 4830 |

The cathode can be the composite electrode materials which have been composite of conducting polymer (polyaniline) with 2D materials (molybdenum disulfide (MoS₂), FeS₂, TiS₂, MoS₂, VS₂, WS₂₎ and 3-D materials (CrS, CuS, NiS, CoS₂, Co₃O₄, ZnFe₂O₄, Co₂O₄—TiO₂, Cu₂O, Vn₂O₅, MnO₂. The electrodes will be used as an asymmetrical supercapacitor. The other electrode can be lithiated activated Si-carbon, lithiated graphene, lithiated MoS₂.

The current collector can be graphite, nickel, aluminum, tantalum, copper, germanium, tungsten, steel. The electrolyte can also be the lithium salts containing ionic liquid (1-ethyl-3-methylimidazolium bis(trifluoromethylsulfonyl)imide (EMI-TFSI), 1-Ethyl-3-methylimidazolium Bis(trifluoromethylsulfonyl)imide [EMIm-Tf2N], and 1-Methyl-1-propyl piperidinium Bis(trifluoromethane)sulfonimide [MPPip-TFSI], etc.). However, using lithium as ion in the SCB shows the potential window from 2.5 to 3.8V. The energy density of the fabricated devices has been studied using various lithium salts (LiBF₄, LiPF₆, LiCl, and LiClO₄) in either an ionic electrolyte-soaked aerogel or a conventional cloth separator.

FIG. 6 shows the preparation of C—Si electrode and removing oxygen in molten salt electrolysis. The stability, conductivity of the Si—C from phytoliths (bio-SiO₂) is the key to the performance of the LIB electrodes and will be thoroughly investigated as carbon materials. Further, the Si—C or N doped Si—C obtained by pyrolysis as well as electrolysis technique (FIG. 6) will be used as an anode by lithium process. The lithium can be incorporated into the electrode by both electrochemical and sputtering techniques for better intercalation/deintercalation of lithium ions. Table 1 shows the various anode materials with theoretical energy density as well as our selected metal pyrite achieving the high energy density.

### Lithiation of the Electrode

The lithiation can be performed at 10 mA/cm² as a function of time. The attention must be paid during discharge of the lithium ions where electrons are released from electrode into the electrolyte and the ions re also released to positive electrode. The lithiation of the first electrode and second electrode will made by keeping Li metal electrode as counter electrode for lithiation process.

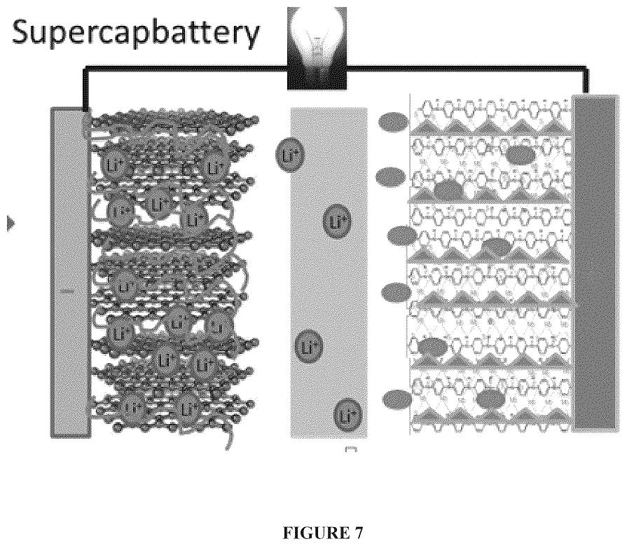

FIG. 7 schematic of a charged supercapbattery without silicon in carbon and schematic of a charged supercapbattery with silicon in carbon in anode electrode.

### Supercapacitor Testing

The electrochemical testing as cyclic voltammetry, charging-discharging, potential widow, and electrochemical impedance spectroscopy tests will be performed to understand the specific capacitance, specific energy, mechanism of charging-discharging, voltage window of the supercapacitor. The supercapacitor will be tested as a function of time the for-stability test. Supercapacitor testing experiment will be performed.

The materials specific capacitance (C_{sc}) can be estimated from the following equation [19]:

$${C}_{SC} = \frac{{\int }_{{E}_{1}}^{{E}_{2}} i ( E ) d E}{2 ( {E}_{2} - {E}_{1} ) m v} \qquad ( 2 )$$

where m and v are the mass of active electrode materials and the scan rate, respectively, and the integrated area between charge and discharge curves is

$${\int }_{{E}_{1}}^{{E}_{2}} i ( E ) d E$$

[20]. The discharge specific capacitance (Cₘ) can be calculated as follows [21]:

$${C}_{m} = \frac{I . Δ t}{Δ V . m} \qquad ( 3 )$$

where m, I, Δt, and ΔV are the mass of active materials, discharge current, time and the voltage difference, respectively [22].

### Open Circuit Potential Monitoring

In this method, first the device is charged up to the maximum voltage. Then the voltage source is removed and the voltage across the device is monitored. The rate of the voltage drop is proportional to the leakage current in the device.

### Impedance Measurement (Nyquist and Bode Plots)

Phase angle (θ) vs. frequency plots (Bode plot) have also been used to examine the ideality of the capacitance behavior of our system. This is explained using the relation: θ=−tan⁻(Z″/Z′), Where Z″ and Z′ are the imaginary and real components of the impedance. So, the semicircular (Nyquist plot) gives an idea of the conductivity of the sample.

### Charging and Discharging Evaluate

The specific capacitance is obtained by C=−1/2πfZ″ where Z″ is the imaginary part of total complex impedance. The single electrode specific capacitance values were evaluated by multiplying the overall capacitance by a factor of two and divided by the mass of a single electrode material. The capacitance values from this technique were evaluated using the relation C=i/s where ‘i’ is the current and ‘s’ is the scan rate. The charge-discharge characteristics of the capacitor cells were evaluated at constant current. The discharge capacitance ‘C_{d}’ is evaluated from the linear part of the discharge curves using the relation C_{d}=iΔt/ΔV where ‘i’ is the constant current and ‘Δt’ is the time interval for the voltage change of ΔV.

### Internal Resistance Measurement

The internal resistance, r, of devices is studied at different discharge currents. The experiment is designed first to charge the supercapacitors, and then monitor the voltage when they are discharged through a load, R. The results demonstrate an exponential voltage drop with a time constant of [(R+r) C]. Finally, the energy density in the capacitors will be calculated from the well-known equation W=½ CV²

### State-of-Charge (SOC) Measurement

The amount of charge being stored and recovered in each cycle will be measured to determine SOC and change in the capacitance. Also, the effect of temperature on performance of the cells will be studied using a custom-made heating-cooling setup. Devices with various thicknesses of the nanocomposite electrode, dielectric layer, and electrolytes will be fabricated and evaluated to find the optimum parameters. The focus of the study will be on devices with organic electrolytes including ionic liquid that can provide cell voltages of ˜2.8 to 3.8 V.

### Testing of Supercapbattery

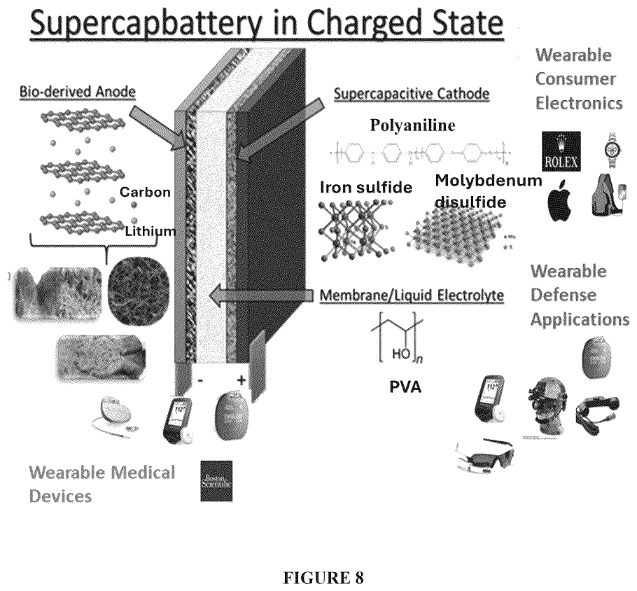

The EIS, charging discharging and cyclic voltammetric study are performed on porotype to optimize the specific capacitance, energy, and power. The life cycle test is performed in charging and discharging mode as a function of time. PolyMaterials's supercapbattery offers lightweight ‘high power and energy’ storage that can save space and weight in wearable equipment used for the military and medical applications. In addition to the high power and energy densities in the SCB, the flexible structure allows for a more efficient and ergonomic design of the equipment with greater cost-effectiveness. The proposed technology provides innovative clean energy and cost-effective improvement on both supercapacitor and battery market. The prototype can be fabricated with target properties of a voltage of 1 to 3.8 V, specific capacitance >600 F/g, and energy density >50-250 Wh/kg and cycle of 10⁵. FIG. 8 shows the schematic of supercapacitor and application as energy storage device.

### REFERENCES

### Addin En.Reflist

1. Zhang, L., et al., A review of supercapacitor modeling, estimation, and applications: A control/management perspective. Renewable and Sustainable Energy Reviews, 2018. 81: p. 1868-1878.
2. Ke, Q. and J. Wang, Graphene-based materials for supercapacitor electrodes—A review. Journal of Materiomics, 2016. 2(1): p. 37-54.
3. Borenstein, A., et al., Carbon-based composite materials for supercapacitor electrodes: a review. Journal of Materials Chemistry A, 2017. 5(25): p. 12653-12672.
4. Gao, Y., Graphene and polymer composites for supercapacitor applications: a review. Nanoscale research letters, 2017. 12(1): p. 387.
5. González, A., et al., Review on supercapacitors: Technologies and materials. Renewable and sustainable energy reviews, 2016. 58: p. 1189-1206.
6. Sharma, P. and T. Bhatti, A review on electrochemical double-layer capacitors. Energy conversion and management, 2010. 51(12): p. 2901-2912.
7. Vangari, M., T. Pryor, and L. Jiang, Supercapacitors: review of materials and fabrication methods. Journal of Energy Engineering, 2012. 139(2): p. 72-79.
8. Nawaz, M. A., et al., Phytolith formation in plants: from soil to cell. Plants, 2019. 8(8): p. 249.
9. Piperno, D. R., New archaeobotanical information on early cultivation and plant domestication involving microplant (phytolith and starch grain) remains. Biodiversity in Agriculture-Domestication, Evolution, and Sustainability, 2012: p. 136-159.
10. Zhang, J., Phytolith Analysis for the Discrimination of Foxtail Millet (Setaria italica) and Green Foxtail (Setaria viridis). Quaternary International, 2012(279-280): p. 558.
11. Ellis, B. L., K. T. Lee, and L. F. Nazar, POsitive Electrode Materials for Li-Ion and Li-Batteries†. Chemistry of Materials, 2010. 22(3): p. 691-714.
12. Li, L., et al., High-purity iron pyrite (FeS2) nanowires as high-capacity nanostructured cathodes for lithium-ion batteries. Nanoscale, 2014. 6(4): p. 2112-2118.
13. Trevey, J. E., C. R. Stoldt, and S.-H. Lee, High Power Nanocomposite TiS2 Cathodesfor All-Solid-State Lithium Batteries. Journal of The Electrochemical Society, 2011. 158(12): p. A1282-A1289.
14. Winter, M., et al., Insertion Electrode Materials for Rechargeable Lithium Batteries. Advanced Materials, 1998. 10(10): p. 725-763.
15. Kim, Y. and J. B. Goodenough, Lithium Insertion into Transition-Metal Monosulfides: Tuning the Position of the Metal 4s Band. The Journal of Physical Chemistry C, 2008. 112(38): p. 15060-15064.
16. Jache, B., et al., Copper sulfides for rechargeable lithium batteries: Linking cycling stability to electrolyte composition. Journal of Power Sources, 2014. 247(0): p. 703-711.
17. Han, S.-C., et al., Electrochemical properties of NiS as a cathode material for rechargeable lithium batteries prepared by mechanical alloying. Journal of Alloys and Compounds, 2003. 349(1-2): p. 290-296.
18. Wang, Y., et al., Phase-Controlled Synthesis of Cobalt Sulfides for Lithium Ion Batteries. ACS Applied Materials & Interfaces, 2012. 4(8): p. 4246-4250.
19. Li, H., et al., Theoretical and experimental specific capacitance of polyaniline in sulfuric acid. Journal of Power Sources, 2009. 190(2): p. 578-586.
20. Kim, M., et al., Fabrication of a polyaniline/MoS 2 nanocomposite using self-stabilized dispersion polymerization for supercapacitors with high energy density. RSC Advances, 2016. 6(33): p. 27460-27465.
21. Gao, Y., et al., Electrochemical capacitance of Co 3 O 4 nanowire arrays supported on nickel foam. Journal of Power Sources, 2010. 195(6): p. 1757-1760.
22. Khawaja, M. K., Synthesis and Fabrication of Graphene/Conducting Polymer/Metal Oxide Nanocomposite Materials for Supercapacitor Applications. 2015: University of South Florida.

We claim:

1. The method of fabrication, manufacturing and characterization of high-power density and high energy density energy storage ‘supercapbattery; device comprises of first electrode, second electrode and electrolyte containing with or without spacer;
the first electrode made from conducting polymer and transition metal sulfide nanocomposite electrode;
the second electrode is made from pyrolyzed conducting polymer coated phytolith based nitrogen doped silicon-carbon (Si—C) with and without lithiated lithium;
The electrolyte is polyvinyl alcohol (PVA) based acid or inorganic salt, ionic liquid, or salt in organic solvent.

2. The first electrode of claim 1 wherein composite of conducting polymer composite with transition metal sulfide which is selected from polyaniline(PANI)-iron sulfide (FeS2), PANI-titanium sulfide (TiS2), PANI-molybdenum sulfide (MoS2), PANI (vanadium sulfide) (VS2), PANI-cromium sulfide (CrS(m PANI-copper sulfide (CuS), PANI-nickel sulfide (NiS2), pol (poly(ortho-anisidine) (POAS)-MoS₂, poly(o-toluidine) (POT)-FeS2, poly(ethoxy-aniline) (POEA))-MoS₂, substituted polyanilines-MoS₂, polypyrroles-MoS₂, substituted polypyrroles-MoS₂, polythiophenes-S, polyindole-MoS₂, polycarbazole-MoS₂, substituted polycarbazole-MoS₂, polypyrrole-MoS₂, polyhexylthiophene-MoS₂ polyethylenedioxythiophene-MoS₂, methylthiophene-MoS₂, polydodcylthiophene-MoS₂, polycarbazole-MoS₂, poly(n-vinylcarbazole)-MoS₂, substituted polyethylenedioxythiophene-MoS₂, polydiooxythiophene-MoS₂, n-Poly(N-methyl aniline)-MoS₂, poly(o-ethoxyaniline), poly(o-toluidine)-MoS₂, poly(phenylene vinylene)-MoS₂, PANI-MoSe₂, PANI-MoTe₂, PANI-WS₂, PANI-WSe₂, PANI-WTe₂ and their combinations.

3. The second electrode of claim 1, wherein is the pyrolyzed composite of phytolith selected from rice (Oryza sativa), sugarcane (Saccharum officinarum), bamboo (bambusoideae), sorghum (Sorghum bicolor), horsetail (equisetum), Eucalyptus containing the salicylic acid with cellulose with conducting polymer (poly(ortho-anisidine) (POAS), poly(o-toluidine) (POT), poly(ethoxy-aniline) (POEA), substituted polyanilines-polypyrroles, substituted polypyrroles-, polythiophenes, polyindole, polycarbazole, substituted polycarbazole, polypyrrole, polyhexylthiophene-polyethylenedioxythiophene, methylthiophene, polydodcylthiophene-, polycarbazole, poly(n-vinylcarbazole), substituted polyethylenedioxythiophene, polydiooxythiophene, n-poly(N-methyl aniline), poly(o-ethoxyaniline), poly(o-toluidine), poly(phenylene vinylene), polyaniline and their combination (s) thereof.

4. The electrolyte of claim 1 is selected on polyvinyl alcohol (PVA)-HCl, PVA-H₃PO₄, or PVA-H₂SO₄ gel electrolyte; or the separator socked ionic liquid ((1-ethyl-3-methylimidazolium bis(trifluoromethylsulfonyl)imide (EMI-TFSI), 1-Ethyl-3-methylimidazolium Bis(trifluoromethylsulfonyl)imide [EMIm-Tf2N], and 1-Methyl-1-propyl piperidinium Bis(trifluoromethane)sulfonimide [MPPip-TFSI], etc.) or combination thereof.

5. The composition of claim 3 is nitrogen doped silicon-carbon structure after pyrolysis.

6. The composition of claim 5 is the electrochemically reduced under molten salt of magnesium chloride silicon oxide to silicon-carbon and doped with nitrogen.

7. The composition of claim 1 comprises of asymmetric electrodes based supercapbattery.

8. The composition of claim 7 supercapbattery performances at high rates of discharge and high energy density and survivability in capable of performing the desired properties of energy density like battery and power density like supercapacitor due to enhancement of lithium ion due to lithiation in second electrode.

9. The characterization of supercapbattery of claim 1 will have specific capacitance of preferably at least 100 to 600 F/g using PVA gel and organic based electrolyte.

10. The characterization of supercapbattery of claim 1 has specific energy density of 50-200 mAh/g with potential well within 1-3.8V.

11. The supercapbattery can be constructed through a very high functional anode or cathode from battery and matching with the other electrode of supercapacitor.
